(19) United States
(12) Patent Application Publication
(10) Pub. No.: US 2010/0164361 A1
(43) Pub. Date: Jul. 1, 2010

(54) PLASMA DISPLAY PANEL PROTECTIVE LAYER

(75) Inventors: Sung-Hwan Moon, Suwon-si (KR); Jae-Hyuk Kim, Suwon-si (KR); Dong-Hyun Kang, Suwon-si (KR); Yury Matulevich, Suwon-si (KR); Hee-Young Chu, Suwon-si (KR); Mi-Hyun Lee, Suwon-si (KR); Chang-Hyuk Kim, Suwon-si (KR); Jong-Seo Choi, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/642,040

(22) Filed: Dec. 18, 2009

(30) Foreign Application Priority Data
Dec. 31, 2008 (KR) 10-2008-0138533

(51) Int. Cl. H01J 1/70; H01J 17/49; B32B 5/00; B32B 9/04; C01F 17/00

(52) U.S. Cl. 313/489; 313/582; 428/220; 428/697; 423/263; 977/952

(57) ABSTRACT

A plasma display panel (PDP) protective layer including a ternary compound in the form of BaXO, wherein X is selected from the group consisting of Sc, Y, Gd, La, Er, Ho, Nd, Sm, and Ce. Such protective layer has excellent electron emission characteristics and phase stability.

### CROSS-REFERENCE TO RELATED APPLICATION

This application claims the benefit of Korean Patent Application No. 10-2008-0138533, filed Dec. 31, 2008, in the Korean Intellectual Property Office, the disclosure of which is incorporated herein by reference.

### BACKGROUND OF THE INVENTION

1. Field of the Invention

Aspects of the present invention relate to a plasma display panel (PDP) protective layer including a ternary compound in the form of BaXO, and more particularly to a PDP protective layer including a single phase Ba₂X₂O₅, Ba₃X₄O₉, or Ba₄X₂O₇.

2. Description of the Related Art

Plasma Display Panels (PDPs) can be used for large screen displays and have good display qualities due to their self-emission and quick response characteristics. Also, PDPs can be formed to be thin, and thus, like liquid crystal displays (LCDs), are suitable for wall displays.

MgO has been used as a material for forming a PDP protective layer for several decades. However, research has been carried out into the development of a new material having better discharge characteristics than MgO in order to increase the efficiency of PDPs. It has been reported that a protective layer prepared using conventional SrCaO has excellent discharge characteristics. However, since the SrCaO is very unstable in the air, it is easily hydrated (˜OH) or the phase of the SrCaO is changed into a carbonate (˜CO₃). If the phase of the SrCaO is changed, electron emission characteristics and mechanical strength deteriorate, and the layer formed of the SrCaO loses its protective capabilities. In order to prevent this phase change, a process of manufacturing the protective layer needs to be strictly controlled using nitrogen or inert gas. In this case, costs for manufacturing the protective layer increase. Furthermore, MₓMg₁₋ₓO has been used to improve characteristics of a protective layer. However, electron emission characteristics cannot be improved since a main material is limited to MgO.

### SUMMARY OF THE INVENTION

Aspects of the present invention provide a plasma display panel (PDP) protective layer having excellent electron emission characteristics and phase stability. Aspects of the present invention also provide a method of manufacturing the PDP protective layer. Aspects of the present invention also provide a PDP including the PDP protective layer.

According to aspects of the present invention, there is provided a plasma display panel (PDP) protective layer including a material selected from a group consisting of Ba₂X₂O₅, Ba₃X₄O₉, and Ba₄X₂O₇, wherein X is selected from a group consisting of Sc, Y, Gd, La, Er, Ho, Nd, Sm, and Ce.

According to aspects of the present invention, the Ba₂X₂O₅may be formed in a single phase by mixing BaO and X₂O₃, in a ratio of 2:1, with a solvent, and sintering the mixture at a temperature of about 1500 to about 1700° C. for about 1 to about 30 hours.

According to aspects of the present invention, the Ba₃X₄O₉may be formed in a single phase by mixing BaO and X₂O₃, in a ratio of 3:2, with a solvent, and sintering the mixture at a temperature of about 1500 to about 1700° C. for about 1 to about 30 hours.

According to aspects of the present invention, the Ba₄X₂O₇may be formed in a single phase by mixing BaO and X₂O₃, in a ratio of 4:1, with a solvent, and sintering the mixture at a temperature of about 1500 to about 1700° C. for about 1 to about 30 hours.

According to aspects of the present invention, the thickness of the PDP protective layer may be in a range of about 300 to about 1000 nm.

According to aspects of the present invention, the X may be selected from the group consisting of Y, Sc, Ho, and La.

According to aspects of the present invention, the secondary electron emission coefficient of the PDP protective layer in response to 55 ms of a single short pulse of Ne gas at 90 eV may be in a range of about 0.4 to about 0.5.

According to aspects of the present invention, the secondary electron emission coefficient of the protective layer in response to 55 ms of a single short pulse of Xe gas at 90 eV may be in a range of about 0.025 to about 0.045.

According to aspects of the present invention, there is provided a method of manufacturing a plasma display panel (PDP) protective layer, the method including: uniformly mixing BaO and X₂O₃, in ratios of 2:1, 3:2, or 4:1, with a solvent; heat-treating the mixture; and forming a deposition layer using the heat-treated material, wherein X is selected from the group consisting of Sc, Y, Gd, La, Er, Ho, Nd, Sm, and Ce.

According to aspects of the present invention, the solvent may be ethyl alcohol, isopropyl alcohol, or n-propanol.

According to aspects of the present invention, the heat-treating of the mixture may include: drying the mixture; and preparing pellets of the dried mixture and sintering the pellets.

According to aspects of the present invention, the drying may be performed at a temperature ranging from about 80 to about 150° C.

According to aspects of the present invention, the sintering may be performed at a temperature ranging from about 1500 to about 1700° C.

According to aspects of the present invention, the forming a deposition layer may be performed using chemical vapor deposition (CVD), E-beam evaporation, ion-plating, or sputtering.

According to another aspect of the present invention, there is provided a plasma display panel (PDP) including: a transparent front substrate; a rear substrate disposed opposite to the front substrate; barrier ribs disposed between the front substrate and the rear substrate to define discharge cells; address electrodes disposed on a front surface of the rear substrate in a rear dielectric layer and extending in a first direction between the barrier ribs extending in the first direction; a phosphor layer disposed in the discharge cells; pairs of sustain electrodes disposed on a rear surface of the front substrate in a front dielectric layer and extending in a second direction to cross the address electrodes; a protective layer disposed on the front dielectric layer and including one selected from a group consisting of Ba₂X₂O₅, Ba₃X₄O₉, and Ba₄X₂O₇; and a discharge gas filled in the discharge cells.

According to aspects of the present invention, the thickness of the protective layer may be in a range of about 300 to about 1000 nm.

According to aspects of the present invention, each of the Ba₂X₂O₅, Ba₃X₄O₉, and Ba₄X₂O₇ may be prepared in a single phase by mixing BaO and X₂O₃, respectively in ratios of 2:1, 3:3, and 4:1, with a solvent, sintering the mixture at a temperature ranging from about 1500 to about 1700° C. for about 1 to about 30 hours.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments, taken in conjunction with the accompanying drawings of which:

FIG. 1 is a perspective view illustrating a plasma display panel (PDP) according to an embodiment of the present invention;

FIG. 2 is a graph illustrating phase analysis of Ba₃Y₄O₉ pellets prepared according to Example 1 using an X-ray diffraction (XRD) device;

FIG. 3 is a graph illustrating discharge voltage characteristics of protective layers prepared according to Example 1 and Comparative Example 1;

FIG. 4 is a graph illustrating secondary electron emission coefficients of protective layers prepared according to Example 1 and Comparative Example 1 by Ne ions;

FIG. 5 is a graph illustrating secondary electron emission coefficients of protective layers prepared according to Example 1 and Comparative Example 1 by Xe ions;

FIG. 6A is a graph illustrating simulation of band gap of a protective layer prepared according to Example 1 using a Vienna Ab-initio Simulation Package (VASP); and

FIG. 6B is a graph illustrating simulation of band gap of a protective layer prepared according to Comparative Example 1 using a VASP.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. It will be understood that when an element such as a layer, film, region, or substrate is referred to as being “formed on” or “disposed on” another element, it can be disposed directly on the other element, or intervening elements may also be present. In contrast, when an element is referred to as being “formed directly on” or “disposed directly on” another element, there are no intervening elements present.

According to an embodiment of the present invention, there is provided a plasma display panel (PDP) protective layer with excellent electron emission characteristics and phase stability, the PDP protective layer including a ternary compound in the form of BaXO, such as Ba₂X₂O₅, Ba₃X₄O₉, or Ba₄X₂O₇, where X is selected from a group consisting of Sc, Y, Gd, La, Er, Ho, Nd, Sm, and Ce.

A secondary electron emission coefficient of a material contained in the PDP protective layer increases as a band gap and an electron affinity decrease. Since conventional MgO has a greater band gap and electron affinity than BaO and SrO, a secondary electron emission coefficient of MgO is relatively smaller than those of BaO and SrO. In addition, SrCaO is very unstable in air, and BaO is even more unstable than SrCaO in air at room temperature. Thus, a PDP protective layer having excellent electron emission characteristics and phase stability may be manufactured using Ba₂X₂O₅, Ba₃X₄O₉, or Ba₄X₂O₇ according to an embodiment.

Each of the Ba₂X₂O₅, Ba₃X₄O₉, or Ba₄X₂O₇ according to an embodiment may be prepared in a single phase by mixing BaO and X₂O₃, respectively, in ratios of 2:1, 3:3, and 4:1, with a solvent, and sintering the mixture at a temperature of about 1500 to about 1700° C. for about 1 to about 30 hours.

As described above, a binary oxide of BaO is very unstable in air. However, phase stability of a ternary complex oxide considerably increases in a single phase. Further, when X is Y, Sc, Ho, or La, i.e., Ba₃Y₄O₉, Ba₃Sc₄O₉, Ba₃Ho₄O₉, or Ba₃La₄O₉, X may be suitably used for a PDP protective layer due to excellent phase stability and thermal electron emission characteristics. The thickness of the PDP protective layer formed of such a ternary barium oxide may be in a range of about 300 to about 1000 nm. If the thickness of the PDP protective layer formed of the ternary barium oxide is less than 300 nm, effects of the protective layer on improving electron emission characteristics may not be sufficient. On the other hand, if the thickness of the PDP protective layer is greater than 1000 nm, adhesion of the layer may decrease, and costs for manufacturing the PDP protective layer may increase even though electron emission characteristics are not changed.

The solvent of the mixture may be alcohol, but is not limited thereto. For example, ethyl alcohol, isopropyl alcohol, or n-propanol may be used since the solvent should be easily removed in a drying process and should have sufficient solubility. The ternary barium oxide is formed in the single phase so as to have excellent phase stability. This single phase cannot be formed by simply mixing BaO and X₂O₃.

The PDP protective layer has a secondary electron emission coefficient in a range of about 0.4 to about 0.5 in response to 55 ms of a single short pulse of Ne gas at 90 eV, and also has a secondary electron emission coefficient in a range of about 0.025 to about 0.045 in response to 55 ms of a single short pulse of Xe gas at 90 eV. Since the secondary electron emission coefficient of the PDP protective layer is greater than that of a conventional MgO protective layer, the PDP protective layer according to an embodiment has excellent properties.

According to an embodiment of the present invention, there is provided a method of manufacturing a PDP protective layer, the method including: uniformly mixing BaO and X₂O₃, respectively in ratios of 2:1, 3:2, or 4:1, with a solvent; heat-treating the mixture; and forming a deposition layer using the heat-treated material. In the uniform mixing of the BaO and X₂O₃ with a solvent, the solvent may be ethyl alcohol, isopropyl alcohol, or n-propanol as described above. The mixing may be performed using a device such as a ball mill, a sieve, or any other mixer without limitation.

The heat-treating of the mixture includes: drying the mixture to remove the solvent; preparing pellets of the dried mixture; and sintering the pellets.

The drying may be performed at a temperature ranging from about 80 to about 150° C. Even though the drying time is not limited, the drying performed at less than 80° C. takes relatively long time to remove the solvent. If the drying is performed at higher than 150° C., cooling time after the drying may be increased.

The dried mixture is pressed to form pellets having a strength suitable for deposition. A single phase of the ternary barium oxide is formed while sintering the pellets at a temperature ranging from about 1500 to about 1700° C. If the sintering is performed at less than 1500° C., a single phase may not be formed. If the sintering is performed at greater than 1700° C., a new phase may be regionally formed, and thus the single phase may not be uniformly formed on the overall region. The sintering may be performed for about 1 to about 30 hours. If the sintering is performed for less than 1 hour, the mixture may not be sufficiently sintered. If the sintering is performed for more than 30 hours, particles may abnormally and excessively grow.

Then, the forming of a deposition layer using the sintered pellets may be performed using a method similar to a conventional method of depositing a MgO protective layer. For example, the formation of the deposition layer may be performed using chemical vapor deposition (CVD), E-beam evaporation, ion-plating, or sputtering.

According to an embodiment of the present invention, there is provided a plasma display panel (PDP) including: a transparent front substrate; a rear substrate which is opposite to the front substrate; barrier ribs disposed between the front substrate and the rear substrate to define or to divide the volume between the front and rear substrates into discharge cells; address electrodes disposed on the rear substrate in a rear dielectric layer and extending in a first direction between the barrier ribs extending in the first direction; a phosphor layer disposed in the discharge cells or on walls of the discharge cells; pairs of sustain electrodes disposed on the front substrate in a front dielectric layer and extending in a second direction to cross the address electrodes; a protective layer disposed on the front dielectric layer and including a material selected from a group consisting of Ba₂X₂O₅, Ba₃X₄O₉, and Ba₄X₂O₇; and a discharge gas filled in the discharge cells.

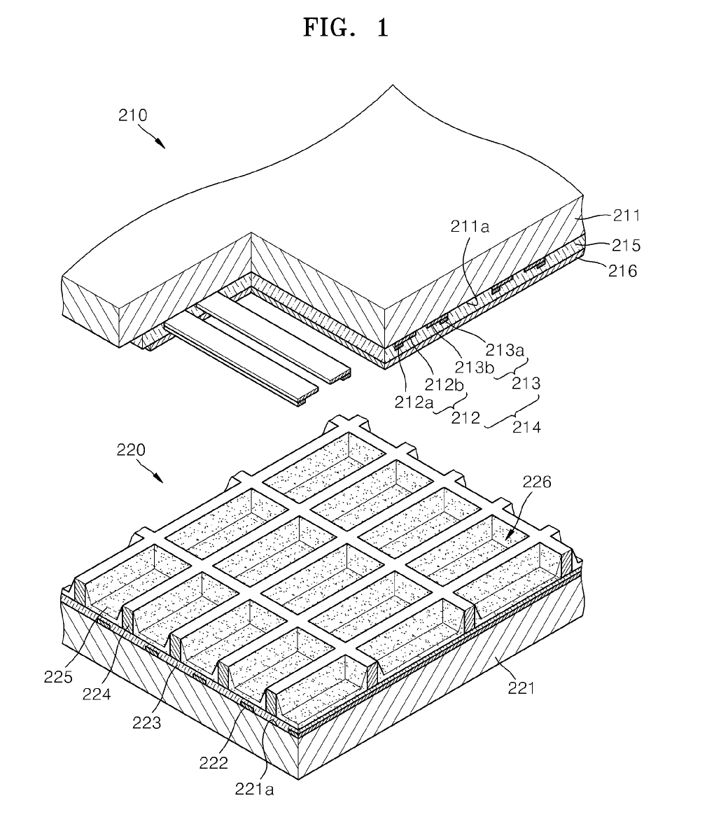

FIG. 1 is a perspective view illustrating a PDP according to an embodiment of the present invention. Referring to FIG. 1, a front panel 210 includes a front substrate 211, pairs of sustain electrodes 214 that are disposed on a rear surface 211a of the front substrate 211 and including Y electrodes 212 and X electrodes 213, a front dielectric layer 215 disposed to cover the pairs of sustain electrodes 214, and a protective layer 216 disposed to cover the front dielectric layer 215 and formed to include Ba₂X₂O₅, Ba₃X₄O₉, or Ba₄X₂O₇. The Y electrodes 212 and the X electrodes 213 respectively include transparent electrodes 212b and 213b formed of ITO, etc., and bus electrodes 212a and 213b formed of a conductive material.

A rear panel 220 includes a rear substrate 221, address electrodes 222 that are disposed on a front surface 221 a of the rear substrate 221 and that extend in a direction crossing the sustain electrodes 214, a rear dielectric layer 223 disposed to cover the address electrodes 222, barrier ribs 224 that are disposed on the rear dielectric layer 223 and define discharge cells 226, and a phosphor layer that is disposed in the discharge cells 226.

The thickness of the PDP protective layer may be in a range of about 300 to about 1000 nm. If the thickness of the PDP protective layer is less than 300 nm, effects of the protective layer on improving electron emission characteristics may not be sufficient. On the other hand, if the thickness of the protective layer is greater than 1000 nm, adhesion of the layer may decrease, and costs for manufacturing the PDP protective layer may increase even though electron emission characteristics are not changed.

Aspects of the present invention will be described in greater detail with reference to the following examples. The following examples are for illustrative purposes and are not intended to limit the scope of the invention.

### EXAMPLE 1

BaO powder and Y₂O₃ powder were weighed such that the atomic ratio of BaO to Y₂O₃ was 3:2. Then, the powders were added to a plastic vessel, zirconia balls were added thereto, and isopropyl alcohol was added thereto as a solvent. Then, the plastic vessel was sealed and the mixture was uniformly mixed using a ball mill for 24 hours.

When the mixing was completed, the plastic vessel was placed in a glass beaker and dried at 100° C. for 3 hours using a drying furnace to remove the solvent. The dried mixture powder was pressed using a mold having a certain shape. Finally, the mixture powder was heat-treated at 1600° C. for 5 hours in order to uniformly form a single phase.

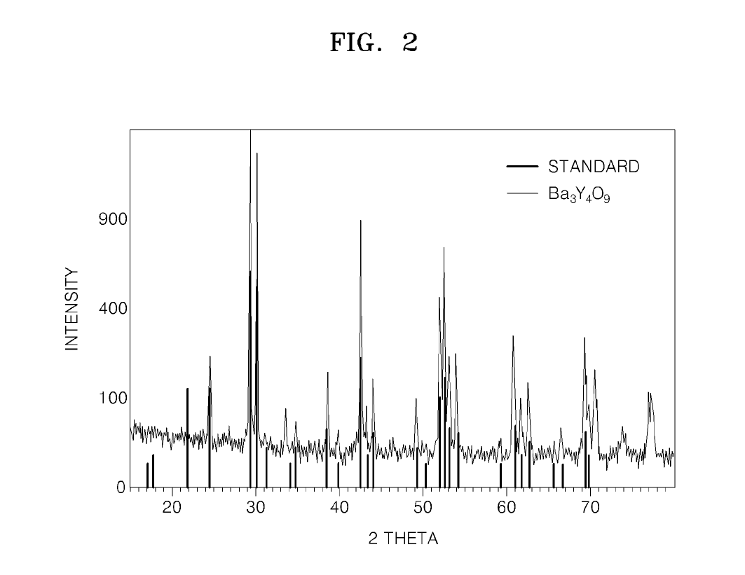

The phase of the prepared Ba₃Y₄O₉ pellets was analyzed using an X-ray diffraction (XRD) device, and the results are shown in FIG. 2. Referring to FIG. 2, the resultant is not a simple mixture of BaO and Y₂O₃ but a single phase of Ba₃Y₄O₉. The “standard” marked in bold lines indicates peaks of Ba₃Y₄O₉ disclosed in the database of the Joint Committee on Power Diffraction Standards (JCPDS), which shows XRD peaks of various types of single materials or complex materials. Since the pellets prepared according to Example 1 exhibit the same XRD peaks as those of Ba₃Y₄O₉ according to JCPDS, it can be identified that the prepared pellets are formed in a single phase.

The prepared uniform pellets were installed in an e-beam evaporation device used to form a protective layer, and a thin layer was formed on an electrode including Ag and a substrate on which a dielectric material was formed using a method used to deposit a conventional protective layer.

### COMPARATIVE EXAMPLE 1

A thin layer was prepared in the same manner as in Example 1, except that MgO is deposited instead of Ba₃Y₄O₉.

### Comparison of Discharge Inception Voltage

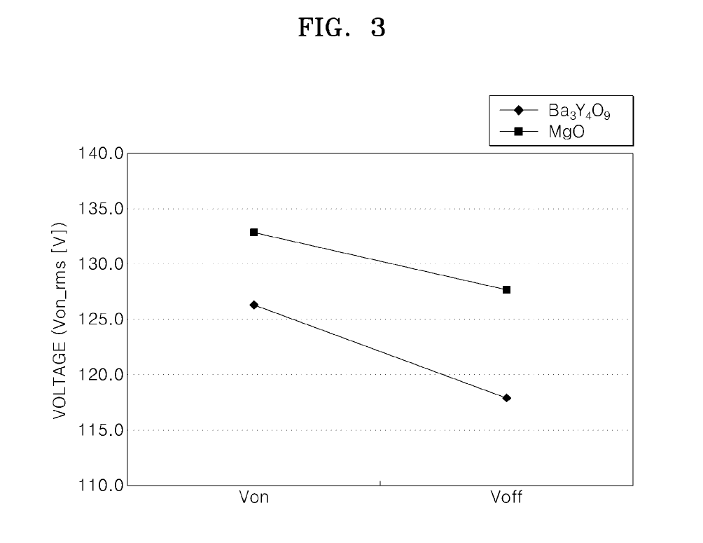

Discharge inception voltages of the protective layers formed using Ba₃Y₄O₉ according to Example 1 and the protective layer formed using MgO according to Comparative Example 1 were measured, and the results are shown in FIG. 3. Referring to FIG. 3, the discharge inception of the protective layer of Example 1 using Ba₃Y₄O₉ was more steeply decreased than that of the protective layer of Comparative Example 1 using MgO.

### Comparison of Secondary Electron Emission Coefficient (Gamma)

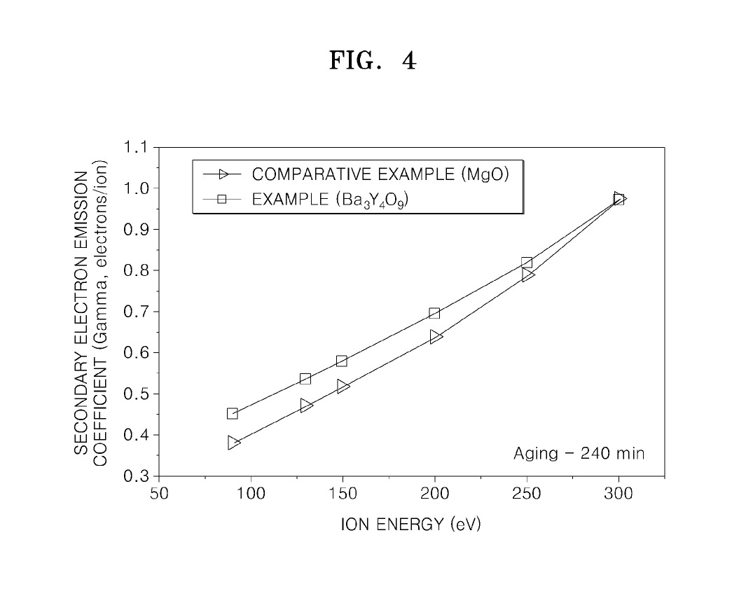

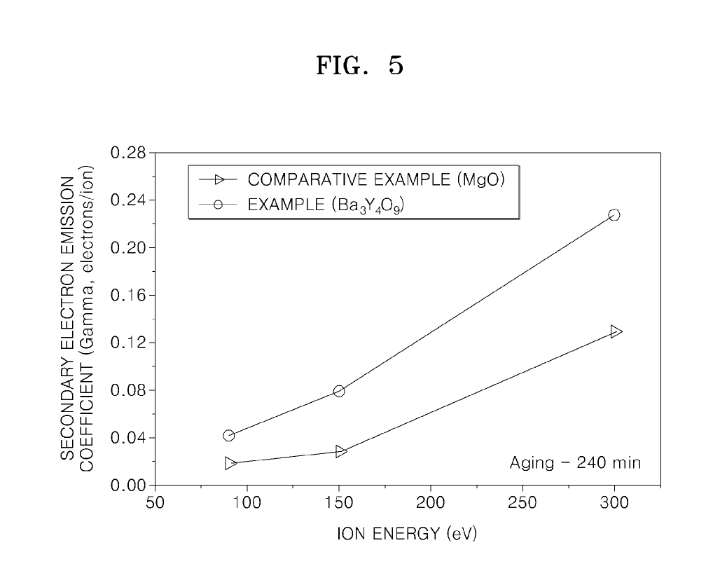

Secondary electron emission coefficients (gammas) of the protective layer formed using Ba₃Y₄O₉ according to Example 1 and the protective layer formed using MgO according to Comparative Example 1 were measured, and the results are shown in FIGS. 4 and 5. FIG. 4 is a graph illustrating secondary electron emission coefficients of Ba₃Y₄O₉ and MgO thin layers by Ne ions. FIG. 5 is a graph illustrating secondary electron emission coefficients of Ba₃Y₄O₉ and MgO thin layers by Xe ions.

In general, a discharge voltage of a protective layer used in PDPs decreases as the secondary electron emission coefficient increases since the protective layer may supply more electrons into the discharge space as the secondary electron emission coefficient increases. Referring to FIGS. 4 and 5, the secondary electron emission coefficient of the Ba₃Y₄O₉ layer by Ne ions and Xe ions was greater than that of the MgO layer, and thus the Ba₃Y₄O₉ layer has better discharge properties than the MgO layer.

### Comparison of Band Gap Simulation

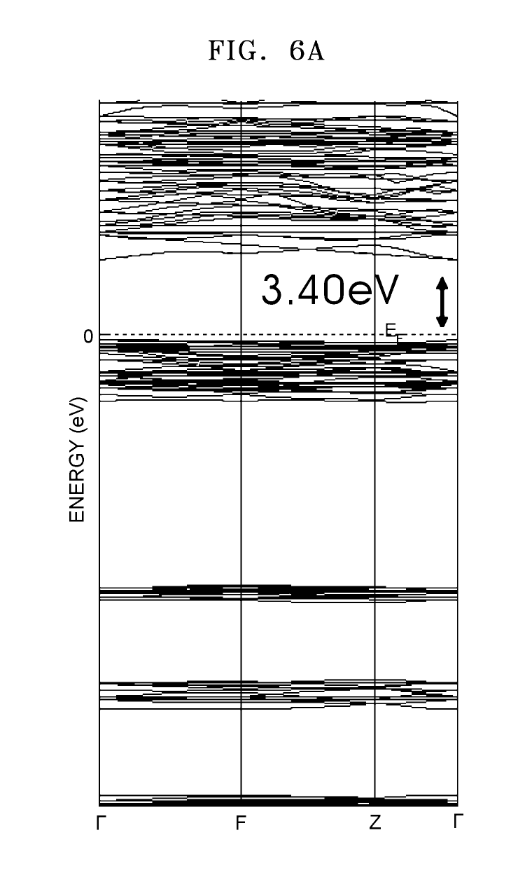

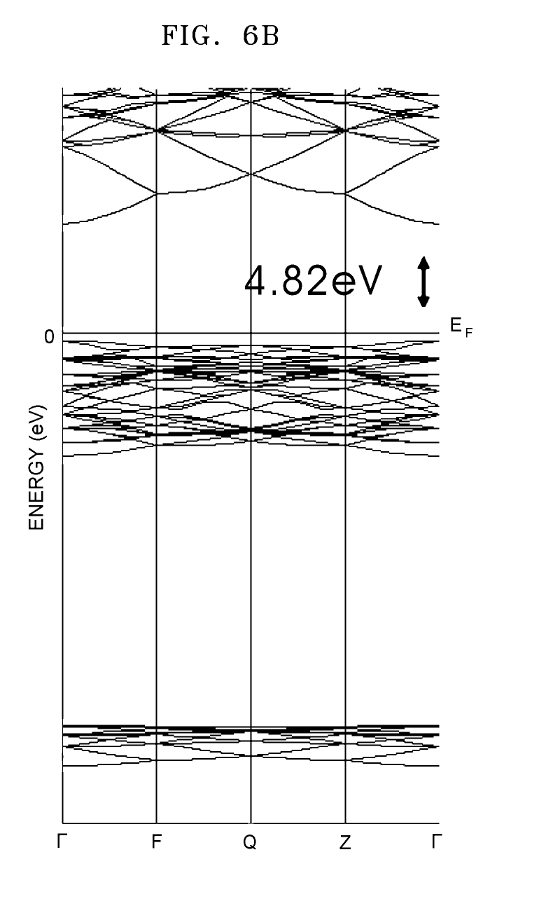

In order to identify the reasons why the Ba₃Y₄O₉ layer has better discharge properties than the MgO layer, Ba₃Y₄O₉ and MgO were simulated using a Vienna Ab-initio Simulation Package (VASP) produced by University of Vienna, and the results are shown in FIGS. 6A and 6B. Referring to FIGS. 6A and 6B, the band gap of the Ba₃Y₄O₉ thin layer according to Example 1, i.e., 3.40 eV, was smaller than the band gap of the MgO thin layer according to Comparative Example 1, i.e., 4.82eV, and thus discharge properties of the Ba₃Y₄O₉ thin layer increased.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A plasma display panel (PDP) protective layer comprising a material selected from the group consisting of Ba₂X₂O₅, Ba₃X₄O₉, and Ba₄X₂O₇, wherein X is selected from the group consisting of Sc, Y, Gd, La, Er, Ho, Nd, Sm, and Ce.

2. The PDP protective layer of claim 1, wherein the Ba₂X₂O₅ is formed in a single phase by mixing BaO and X₂O₃, in a ratio of 2:1, with a solvent, and sintering the mixture at a temperature of about 1500 to about 1700° C. for about 1 to about 30 hours.

3. The PDP protective layer of claim 1, wherein the Ba₃X₄O₉ is formed in a single phase by mixing BaO and X₂O₃, in a ratio of 3:2, with a solvent, and sintering the mixture at a temperature of about 1500 to about 1700° C. for about 1 to about 30 hours.

4. The PDP protective layer of claim 1, wherein the Ba₄X₂O₇ is formed in a single phase by mixing BaO and X₂O₃, in a ratio of 4:1, with a solvent, and sintering the mixture at a temperature of about 1500 to about 1700° C. for about 1 to about 30 hours.

5. The PDP protective layer of claim 1, wherein the thickness of the PDP protective layer is in a range of about 300 to about 1000 nm.

6. The PDP protective layer of claim 1, wherein X is selected from the group consisting of Y, Sc, Ho, and La.

7. The PDP protective layer of claim 1, wherein the secondary electron emission coefficient of the PDP protective layer in response to 55 ms of a single short pulse of Ne gas at 90 eV is in a range of about 0.4 to about 0.5.

8. The PDP protective layer of claim 1, wherein the secondary electron emission coefficient of the protective layer in response to 55 ms of a single short pulse of Xe gas at 90 eV is in a range of about 0.025 to about 0.045.

9. A method of manufacturing a plasma display panel (PDP) protective layer, the method comprising:
uniformly mixing BaO and X₂O₃, in ratios of 2:1, 3:2, or 4:1, with a solvent;
heat-treating the mixture; and
forming a deposition layer using the heat-treated material,
wherein X is selected from the group consisting of Sc, Y, Gd, La, Er, Ho, Nd, Sm, and Ce.

10. The method of claim 9, wherein the solvent is ethyl alcohol, isopropyl alcohol, or n-propanol.

11. The method of claim 9, wherein the heat-treating of the mixture comprises:
drying the mixture;
preparing pellets of the dried mixture; and
sintering the pellets.

12. The method of claim 11, wherein the drying is performed at a temperature ranging from about 80 to about 150° C.

13. The method of claim 11, wherein the sintering is performed at a temperature ranging from about 1500 to about 1700° C.

14. A plasma display panel (PDP) comprising:
a transparent front substrate;
a rear substrate disposed opposite to the front substrate;
barrier ribs disposed between the front substrate and the rear substrate to define discharge cells;
address electrodes disposed on a front surface of the rear substrate in a rear dielectric layer and extending in a first direction between the barrier ribs extending in the first direction;
a phosphor layer disposed in the discharge cells;
pairs of sustain electrodes disposed on a rear surface of the front substrate in a front dielectric layer and extending in a second direction to cross the address electrodes;
the protective layer of claim 1 disposed on the front dielectric layer; and
a discharge gas filled in the discharge cells.

15. The PDP of claim 14, wherein the thickness of the protective layer is in a range of about 300 to about 1000 nm.

16. The PDP of claim 14, wherein the Ba₂X₂O₅ is formed in a single phase by mixing BaO and X₂O₃, in a ratio of 2:1, with a solvent, and sintering the mixture at a temperature ranging from about 1500 to about 1700° C. for about 1 to about 30 hours.

17. The PDP of claim 14, wherein the Ba₃X₄O₉ is formed in a single phase by mixing BaO and X₂O₃, in a ratio of 3:3, with a solvent, and sintering the mixture at a temperature of about 1500 to about 1700° C. for about 1 to about 30 hours.

18. The PDP of claim 14, wherein the Ba₄X₂O₇ is formed in a single phase by mixing BaO and X₂O₃, in a ratio of 4:1, with a solvent, and sintering the mixture at a temperature of about 1500 to about 1700° C. for about 1 to about 30 hours.

19. A plasma display panel (PDP), comprising:
a front substrate;
a rear substrate disposed opposite to the front substrate;
a protective layer disposed on a rear surface of the front substrate, the protective layer comprising a single phase, ternary barium oxide.

20. The PDP of claim 19, wherein the single phase, ternary barium oxide is one selected from the group consisting of Ba₂X₂O₅, Ba₃X₄O₉, and Ba₄X₂O₇.

21. The PDP of claim 20, wherein X is selected from the group consisting of Sc, Y, Gd, La, Er, Ho, Nd, Sm, and Ce.

22. The PDP of claim 21, wherein X is selected from the group consisting of Y, Sc, Ho, and La.

23. The PDP of claim 19, wherein the thickness of the protective layer is in a range of about 300 to about 1000 nm.
